(19) United States
(12) Patent Application Publication
(10) Pub. No.: US 2016/0283954 A1
(43) Pub. Date: Sep. 29, 2016

(54) SYSTEM AND METHOD FOR DETERMINING A COMBINED EFFECTIVE PRICE DISCOUNT IN TIER PRICING

(71) Applicant: ORACLE INTERNATIONAL CORPORATION, Redwood Shore, CA (US)

(72) Inventors: Ming LEI, Lutherville-Timonium, MD (US); Catalin POPESCU, Atlanta, GA (US)

(21) Appl. No.: 14/670,798

(22) Filed: Mar. 27, 2015

(51) Int. Cl. G06Q 30/02

(52) U.S. Cl. CPC G06Q 30/0202; G06Q 30/0211; G06Q 30/0276

(57) ABSTRACT

Systems, methods, and other embodiments are disclosed that are associated with forecasting and management of an item to be promoted via tier pricing. In one embodiment, historical sales data of the item are analyzed and a numerical amount, representing a total number of the item sold, is distributed across a plurality of tier discount ranges of a tier pricing promotion plan for the item. The distribution forms a plurality of distributed values and is based at least in part on discounted sales of the item reflected in the historical sales data. A combined discount value is generated based at least in part on the plurality of tier discount ranges and the plurality of distributed values. A promotional demand value is generated based at least in part on the combined discount value.

### BACKGROUND

A retail business needs to manage its supply chain of products. In one aspect, computer applications are used to manage inventory of products and determine demand forecasts based on promotions. Forecasting demand is a big part of managing a retail business and is a key driver of the supply chain. In retail, when a product (e.g., a cellular telephone) is promoted, the sales of the promoted product will usually increase.

Retailers often use promotions to boost the sales of items. There are many ways to promote a product (e.g., commercials, price discount, buy two items and get one item free, etc.). The price discount is used very often as a promotion tool and tends to be very effective. Retailers use sales and promotion history to predict how a price change for an item will impact a demand for the item.

Among the various types of price promotion strategies, one strategy is tier pricing. Tier pricing is a mechanism to price the same item differently, depending on the purchase quantity. Tier pricing can be an effective way to move more merchandise and may appeal to customers who buy more than one unit of an item at a time. For example, in on-line retailing, when a customer adds a certain quantity of a product to their cart, the price may be automatically changed to reflect the discount. The challenge is to estimate how the promotion of an item based on tier pricing will impact the demand for the item, since the final selling price can vary for each transaction.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one example embodiment of a computer system, having a computing device configured with a promotion forecasting tool;

FIG. 2 illustrates one example embodiment of a method, which can be performed by the promotion forecasting tool of the computer system of FIG. 1, for forecasting a demand for an item due to a planned tier pricing promotion of the item;

FIG. 3A illustrates one example embodiment of a table of data representing the price elasticity and the baseline demand of two items to be promoted via tier pricing;

FIG. 3B illustrates one example embodiment of a table of data representing historical sales data for the items of FIG. 3A;

FIG. 4 illustrates one example embodiment of a table of data representing a tier pricing promotion plan for a first of the two items of FIG. 3A generated based on the table of data of FIG. 3B;

FIG. 5 illustrates one example embodiment of a table of data representing a tier pricing promotion plan for a second of the two items of FIG. 3A generated based on the table of data of FIG. 3B;

FIG. 6 illustrates one example embodiment of a table of data representing combined discount values for the items of FIG. 3A generated based on the tables of data of FIG. 4 and FIG. 5;

FIG. 7 illustrates one example embodiment of a table of data representing promotional demand values for the items of FIG. 3A generated based on the tables of data of FIG. 3A and FIG. 6; and

FIG. 8 illustrates one example embodiment of a computing device upon which a promotion forecasting tool of a computing system may be implemented.

### DETAILED DESCRIPTION

Systems, methods, and other embodiments are disclosed that determine and generate a combined effective price discount for retail items when promotion effects of tier pricing are applied to prices of the retail items. Example embodiments are discussed herein with respect to a computerized system that implements demand forecasting and management of retail data, where tier pricing effects of retail items are used in generating forecasting data. In one embodiment, a promotion forecasting tool is disclosed that is configured to determine a combined discount value that represents an effective price discount for an item under a tier pricing promotion plan. The combined discount value may be used to determine a promotional demand value for the item. The promotional demand value represents an expected total demand for the item under the tier pricing promotion plan. Managing promotions of retail items to accurately forecast demand, balance inventory, and promote maximization of sales revenue is disclosed herein.

The following terms are used herein with respect to various embodiments.

The term “item” or “retail item”, as used herein, refers to merchandise sold, purchased, and/or returned in a sales environment.

The term “period” or “retail period”, as used herein, refers to a unit increment of time (e.g., a 7-day week) which sellers use to correlate seasonal periods from one year to the next in a calendar for the purposes of planning and forecasting. The terms “period”, “retail period”, and “calendar period” may be used interchangeably herein.

The term “location” or “retail location”, as used herein, may refer to a physical store where an item is sold, or to an on-line store via which an item is sold.

The term “discounting” along with its various forms, as used herein, refers to decreasing the sales price of an item in an attempt to increase a demand for the item.

The term “historical sales data”, as used herein, refers to sales and promotion information that have been recorded for an item that has been promoted and sold in past retail periods at various price points (i.e., the item has been discounted).

The term “tier pricing promotion plan”, as used herein, refers to a plan for promoting an item by offering different numbers of units of an item for sale at different price points or discount percentages. A tier pricing promotion plan has multiple tier discount ranges effectively defining the different price points or discount percentages. For example, one tier discount range may correspond to a buyer getting a 10% discount (a tier price discount) off of the regular price of an item when two units of the item are purchased. Another tier discount range may correspond to the buyer getting a 13% discount (tier price discount) off of the regular price of the item when three units of the item are purchased. In one embodiment, the multiple tier discount ranges are defined in a data structure.

In one embodiment, a computer algorithm is disclosed that implements a combinatorial approach to determining promotion effects in tier-based promotion planning and demand forecasting activities. It is assumed herein that historical sales data is available for use. For example, when the historical sales data includes discount sales data, the amount of a product sold at different price points may be determined from the data.

In accordance with one embodiment, for an item to be promoted based on tier pricing, a plurality of tier discount ranges may be defined. A numerical amount representing a total number of the item previously promoted and sold may be determined from the historical sales data and distributed across the plurality of tier discount ranges based on the history. A combined discount value may be determined based on the defined tier discount ranges and the distribution of the numerical amount. The combined discount value is a single value representing an effective price discount for the item. The combined discount value may be used along with a baseline demand value and a price elasticity value for the item, for example, to determine a promotional demand value for the item. The promotional demand value represents an expected total demand for the item when promoted in accordance with the defined tier discount ranges.

Such a combinatorial approach allows a seller (e.g., a retailer) to gain insight into the tier-based promotion effects on merchandise and enables the retailer to more effectively manage promotion planning, demand forecasting, and inventory. A seller can realize significant revenue and/or profit increase by more effectively promoting merchandise and by having the right inventory levels. In the following, a computer-implemented methodology to estimate the promotion effects of tier pricing of an item is presented. In one embodiment, a promotion forecasting tool is configured to perform the methodology.

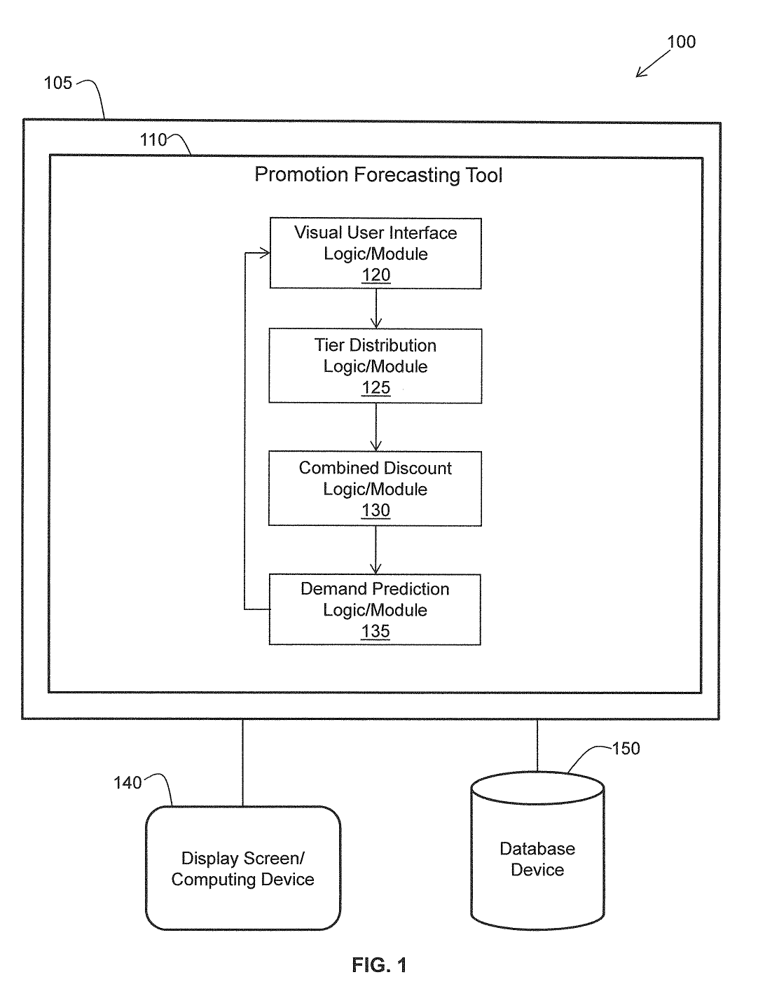

FIG. 1 illustrates one example embodiment of a computer system 100, having a computing device 105 configured with a promotion forecasting tool 110. In one embodiment, the promotion forecasting tool 110 may be part of a larger computer application configured to forecast and manage sales and promotions for retail items at various retail locations. The promotion forecasting tool 110 is configured to computerize the process for predicting tier pricing promotion effects. In one embodiment, the software and computing device 105 may be configured to operate with or be implemented as a cloud-based networking system, a software-as-a-service (SaaS) architecture, or other type of computing solution.

With reference to FIG. 1, in one embodiment, the promotion forecasting tool 110 is implemented on the computing device 105 and includes logics for implementing various functional aspects of the promotion forecasting tool 110. In one embodiment, the promotion forecasting tool 110 includes visual user interface logicv120, tier distribution logic 125, combined discount logic 130, and demand prediction logic 135.

The computer system 100 also includes a display screen 140 operably connected to the computing device 105. In accordance with one embodiment, the display screen 140 is implemented to display views of and facilitate user interaction with a graphical user interface (GUI) generated by the visual user interface logic 120 for viewing and updating information associated with tier pricing promotion effects. The graphical user interface may be associated with a promotion forecasting application and the visual user interface logic 120 may be configured to generate the graphical user interface. In one embodiment, the promotion forecasting tool 110 is a centralized server-side application that is accessed by many users. Thus the display screen 140 may represent multiple computing devices/terminals that allow users to access and receive services from the promotion forecasting tool 110 via networked computer communications.

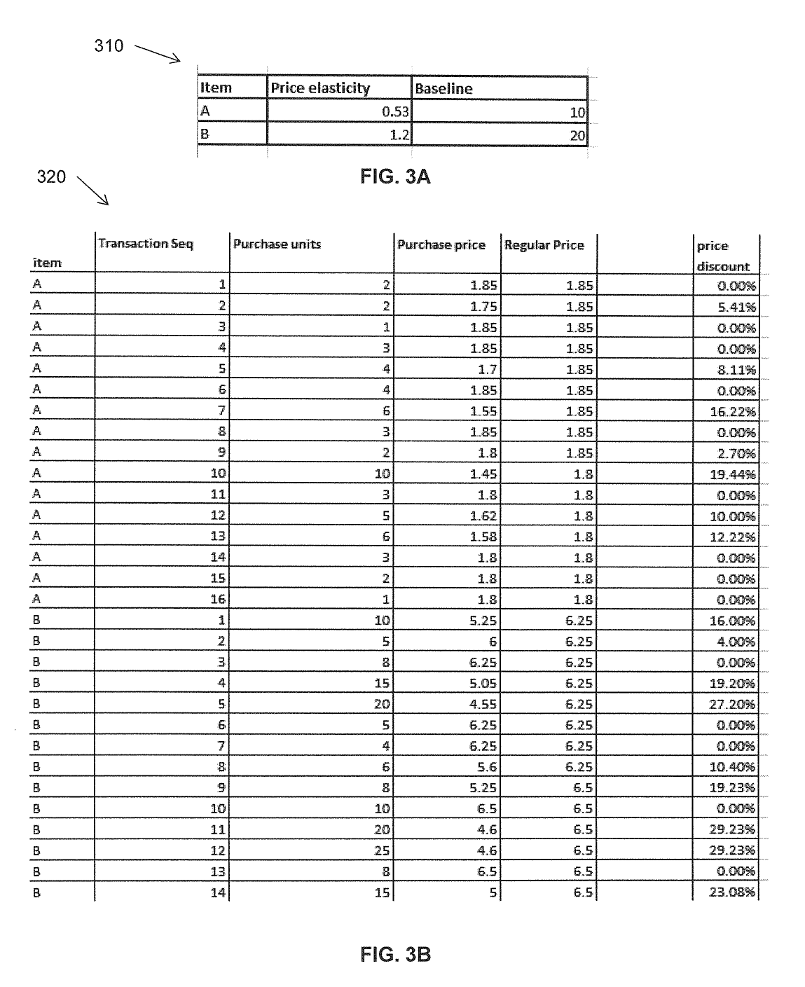

In one embodiment, the computer system 100 further includes at least one database device 150 operably connected to the computing device 105 and/or a network interface to access the database device 150 via a network connection. For example, in one embodiment, the database device 150 is operably connected to the visual user interface logic 120. In accordance with one embodiment, the database device 150 is configured to store and manage data structures (e.g., records of historical sales data, price elasticity values, and baseline demand values) associated with the promotion forecasting tool 110 in a database system (e.g., a computerized inventory and demand forecasting application). Baseline demand values, price elasticity values, and historical sales data are discussed later herein with respect to FIG. 3A and FIG. 3B.

Other embodiments may provide different logics or combinations of logics that provide the same or similar functionality as the promotion forecasting tool 110 of FIG. 1. In one embodiment, the promotion forecasting tool 110 is an executable application including algorithms and/or program modules configured to perform the functions of the logics. The application is stored in a non-transitory computer storage medium. In other words, in one embodiment, the logics of the tool 110 are implemented as modules of instructions stored on a computer-readable medium.

Referring back to the logics of the promotion forecasting tool 110 of FIG. 1, in one embodiment, the visual user interface logic 120 is configured to generate a graphical user interface (GUI) to facilitate user interaction with the promotion forecasting tool 110. For example, the visual user interface logic 120 includes program code that generates and causes the graphical user interface to be displayed based on an implemented graphical design of the interface. In response to user actions and selections via the GUI, associated aspects of tier pricing promotion for retail items may be manipulated.

For example, in one embodiment, the visual user interface logic 120 is configured to facilitate receiving inputs and reading data in response to user actions. For example, the visual user interface logic 120 may facilitate selection and reading of historical sales data, price elasticity values, and baseline demand values associated with retail items sold at a retail location. The historical sales data, price elasticity values, and baseline demand values may reside in at least one data structure (e.g., within database device 150) associated with (and accessible by) a promotion forecasting application (e.g., the promotion forecasting tool 110) via the graphical user interface. Demand for the retail items is affected by promotion (via tier pricing) of the retail items at the retail location.

Historical sales data may include, for example, data representing past sales of an item across a plurality of past retail periods. The historical sales data may reflect discounted sales of the item, with a number of items sold at an associated discounted price. The historical sales data may be segmented into retail periods of past weeks, with each past week having numerical values assigned to it to indicate the number of items sold for that week, in accordance with one embodiment.

The historical sales data, a price elasticity value, and a baseline demand value for an item may be accessed via network communications. In one embodiment, a price elasticity value and a baseline demand value are estimated based at least in part on the historical sales data. A price elasticity value represents a measure of how a demand for an item responds to a change in a price of the item. A baseline demand value represents a demand for an item when the item is not discounted.

Furthermore, the visual user interface logic 120 is configured to facilitate the outputting and displaying of combined discount values and promotional demand values, via the graphical user interface, on the display screen 140. A combined discount value represents an effective price discount (e.g., as a percentage value) for an item when the item is discounted in accordance with a tier pricing promotion plan. A promotional demand value represents an expected total demand (e.g., in number of units of the item) for an item when the item is discounted in accordance with a tier pricing promotion plan. In one embodiment, demand prediction logic 135 is configured to operably interact with the visual user interface logic 120 to facilitate displaying of a combined discount value and associated promotional demand value of an output data structure.

In one embodiment, the tier distribution logic 125 is configured to analyze historical sales data for an item with respect to a plurality of defined tier discount ranges. The tier discount ranges may be part of a tier pricing promotion plan for a future promotion of the item and may define, for example, categories having percentage levels of discounting for the item (e.g., tier price discount values or TPD values). The historical sales data reflects at least discounted sales of the item (e.g., possibly undiscounted sales data as well).

Analyzing the historical sales data also includes determining a numerical amount representing total units of the item sold (total units sold). For example, the historical sales data may indicate that a thousand (1000) units of the item were sold over a six-month period. The items may have been promoted via price discounting at various times during the six-month period.

Units of the item that sold at particular price points may be identified as part of analyzing the historical sales data. The tier distribution logic 125 is configured to distribute the numerical amount (representing total units of the item sold) across the plurality of tier discount ranges. The distributing is directed at least in part by discounted sales of the item reflected in the historical sales data (as determined by analyzing the historical sales data) and results in a plurality of distributed values.

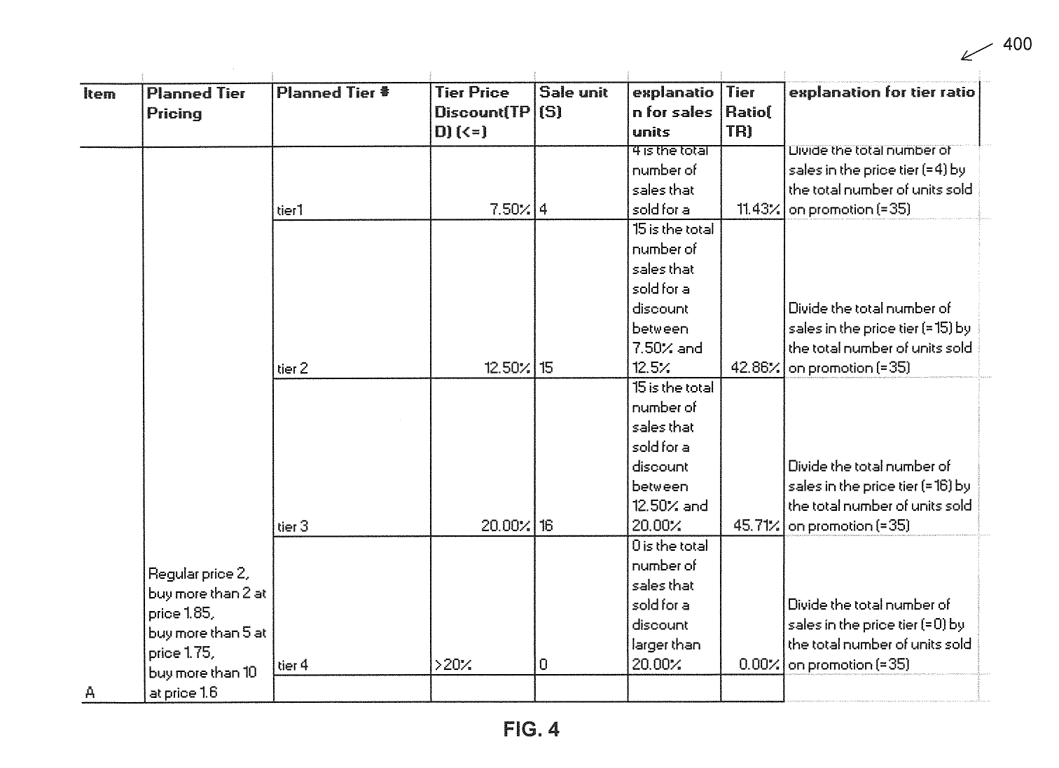

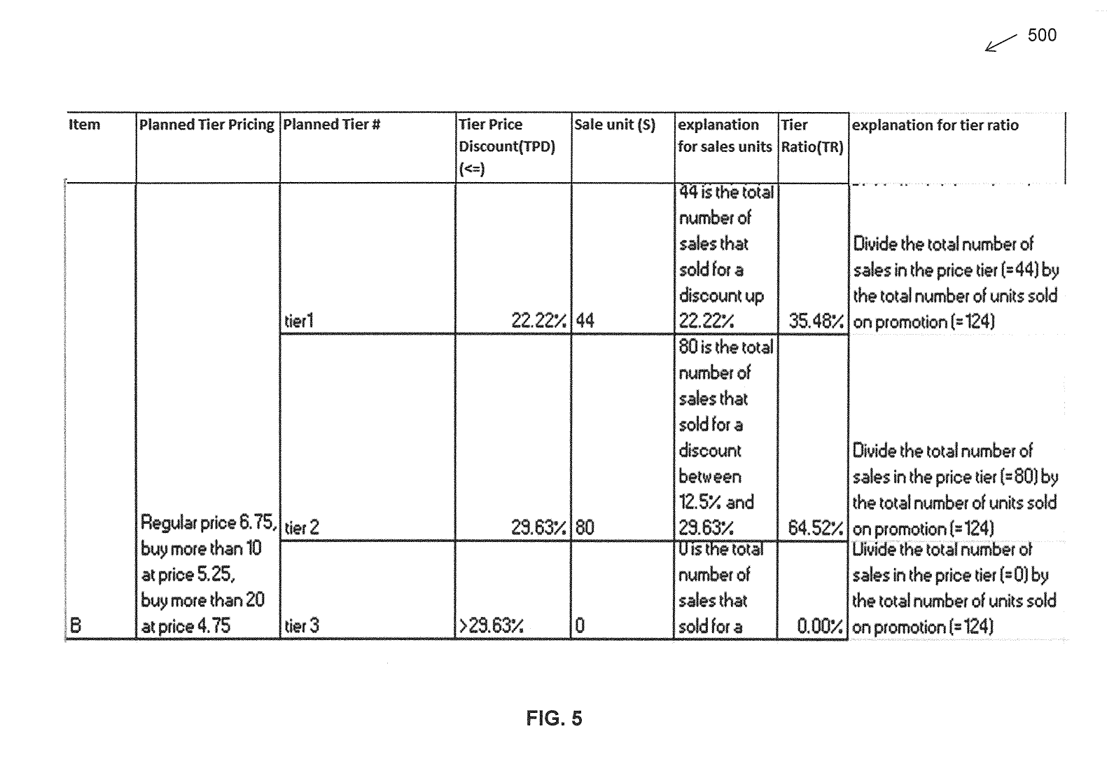

An example of analyzing the historical sales data and distributing a numerical amount across defined tier discount ranges is discussed later herein with respect to FIG. 3B, FIG. 4, and FIG. 5. Furthermore, in accordance with one embodiment, baseline demand values and price elasticity values may be derived from (e.g., may be calculated using) the historical sales data by the tier distribution logic 125.

In one embodiment, the combined discount logic 130 is operably connected to the tier distribution logic 125. The combined discount logic 130 is configured to generate a combined discount value based at least in part on the tier discount ranges (having the TPD values) and the associated distributed values. The combined discount value represents an effective price discount for the item.

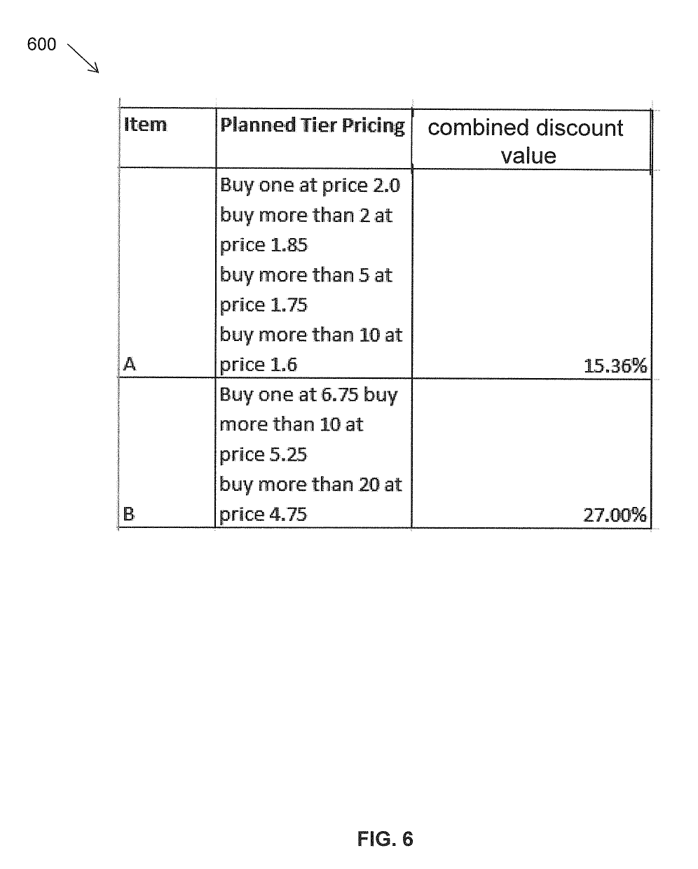

In one embodiment, the combined discount logic 130 is configured to generate a plurality of tier ratio (TR) values, as part of generating the combined discount value, based at least in part on normalizing the plurality of distributed values to the numerical amount representing the total number of the item sold. An example of generating tier ratio values is discussed later herein with respect to FIG. 4 and FIG. 5. An example of generating combined discount values is discussed later herein with respect to FIG. 6.

In one embodiment, the demand prediction logic 135 is operably connected to the combined discount logic 130. The demand prediction logic 135 is configured to generate a promotional demand value for the item based at least in part on the combined discount value. The promotional demand value represents an expected total demand for the item when discounted according to the tier pricing promotion plan (i.e., according to the defined tier discount ranges).

In one embodiment, the demand prediction logic 135 is configured to generate the promotional demand value for the item based on the combined discount value for the item, a baseline demand value for the item, and a price elasticity value for the item. Again, the baseline demand value represents a demand for the item when the item is not discounted. The price elasticity value represents a measure of how a demand for the item responds to a change in a price of the item.

In accordance with one embodiment, the demand prediction logic 135 is configured to transform an output data structure (e.g., associated with the promotion forecasting tool 110) by populating the output data structure with a combined discount value and a promotional demand value for an item. Furthermore, the demand prediction logic 135 is configured to operably interact with the visual user interface logic 120 to facilitate displaying, on the display screen 140, the combined discount value and the promotional demand value in the output data structure via the graphical user interface.

In this manner, a promotion forecasting tool 110 (e.g., implemented as part of a larger computer application) can accurately predict the effects of tier pricing promotion for a retail item. As a result, using such a promotion forecasting tool 110, a retailer may use the predictions to more accurately determine a promotion strategy (e.g., which retail item to promote at which tier discount ranges) and more accurately determine a quantity of the retail item to order.

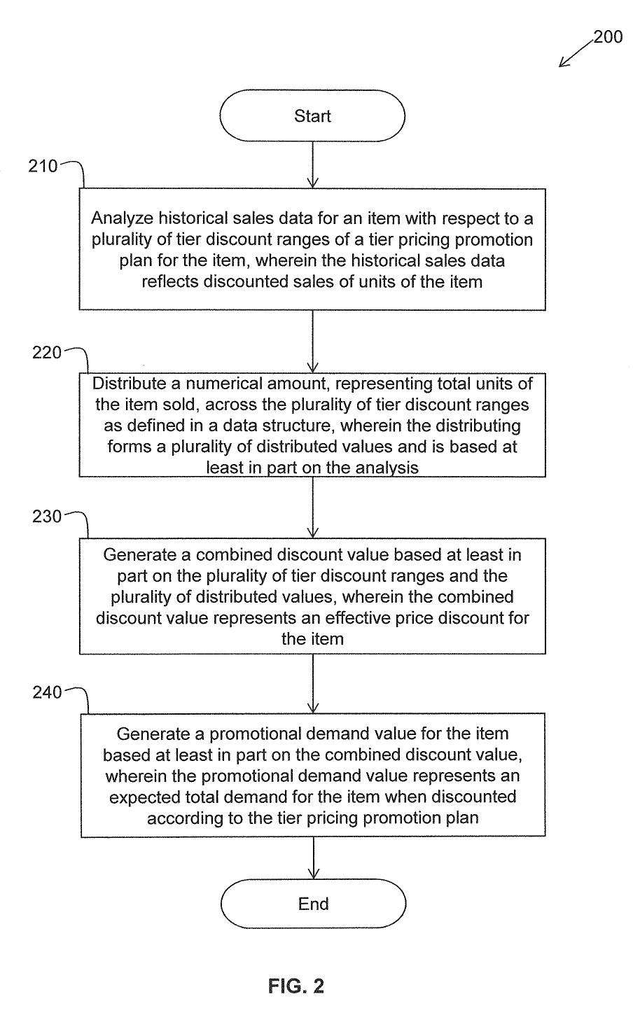

FIG. 2 illustrates one example embodiment of a method 200, which can be performed by the promotion forecasting tool 110 of the computer system 100 of FIG. 1, to forecast a demand for an item due to a planned tier pricing promotion of the item. Method 200 summarizes the operation of the promotion forecasting tool 110 and is implemented to be performed by the promotion forecasting tool 110 of FIG. 1, or by a computing device configured with an algorithm of the method 200. For example, in one embodiment, method 200 is implemented by a computing device configured to execute a computer application. The computer application is configured to process data in electronic form and includes stored executable instructions that perform the functions of method 200.

Method 200 will be described from the perspective that, for an item (e.g., a retail item) sold at a location (e.g., a retail location), the demand of the item is affected by price tier promotion of the item at the location. Also, a retail calendar has many retail periods (e.g., weeks) that are organized in a particular manner (e.g., four (4) thirteen (13) week quarters) over a typical calendar year. A retail period may occur in the past or in the future. An item that is promoted over one or more retail periods may result in an increase in sales (demand) for the item. An example of the method 200 is discussed later herein with respect to FIG. 3A to FIG. 7.

In accordance with one embodiment, the promotion forecasting tool 110 is configured to read historical sales data from at least one data structure (e.g., from data structures in the database 150). The historical sales data represents past sales of the item across a plurality of past retail periods at various price points (e.g., discounted and undiscounted price points), in accordance with one embodiment. The historical sales data may also include a baseline demand value for the item and a price elasticity value for the item. The baseline demand value and the price elasticity value may be derived from other portions of the historical sales data, in accordance with one embodiment.

Upon initiating method 200, at block 210, the historical sales data for an item is analyzed with respect to a plurality of tier discount ranges. The historical sales data may reflect at least discounted sales of units of the item. The tier discount ranges may be defined by a user as part of a tier pricing promotion plan for the item. For example, a user may decide to have four (4) tier discount ranges having four (4) tier price discount (TPD) values defining discounts with respect to a regular sales price. The four (4) tier discount ranges may be, for example, a range of 0% to 7.5% (representing a TPD value of 7.5%), a range of 7.5% to 12.5% (representing a TPD value of 12.5%), a range of 12.5% to 20% (representing a TPD value of 20%), and a range of >20% (representing TPD values that are greater than 20%).

In one embodiment, the tier distribution logic 125 is configured to analyze the historical sales data. Analyzing the historical sales data may determine a numerical amount representing total units of the item sold over a period of time defined by the historical sales data. Furthermore, analyzing the historical sales data may include identifying units of the item that sold at particular price points (e.g., particular discounted prices). An example of such historical sales data is discussed later herein with respect to FIG. 3B.

At block 220 of method 200, the numerical amount representing total units of the item sold is distributed across the plurality of tier discount ranges to form a plurality of distributed values. The distribution is based on the analysis of the historical sales data. For example, if there are 50 total units of an item sold and four (4) tier discount ranges as discussed above, the 50 units may be distributed across the four (4) tier discount ranges as 11 units, 15 units, 21 units, and 3 units, respectively. In one embodiment, the distribution is performed by the tier distribution logic 125.

For example, the 11 units falling within the first tier discount range were sold when the price of a unit was discounted somewhere between 0% and 7.5%. The 15 units falling within the second tier discount range were sold when the price of each unit was discounted somewhere between 7.5% and 12.5%. The 21 units falling within the third tier discount range were sold when the price of each unit was discounted somewhere between 12.5% and 20%. The 3 units falling within the fourth tier discount range were sold when the price of each unit was discounted at greater than 20%. Another example of such a distribution of a numerical amount is discussed later herein with respect to FIG. 4 and FIG. 5.

At block 230, a combined discount value is generated. The combined discount value represents an effective price discount for the item and is generated based at least in part on the plurality of tier discount ranges (each having a tier price discount value) and the plurality of distributed values corresponding to the tier discount ranges. The combined discount value essentially consolidates the distributed values distributed across the tier discount ranges into a single effective value.

For example, the combined discount value may be expressed as a percentage (e.g., 10.26% off of the regular price for the item). In accordance with one embodiment, the combined discount value is generated by the combined discount logic 130 of the promotion forecasting tool 110. In one embodiment, generating the combined discount value includes generating a plurality of tier ratio values based at least in part on normalizing the plurality of distributed values to the numerical amount. An example of generating combined discount values is discussed later herein with respect to FIG. 6.

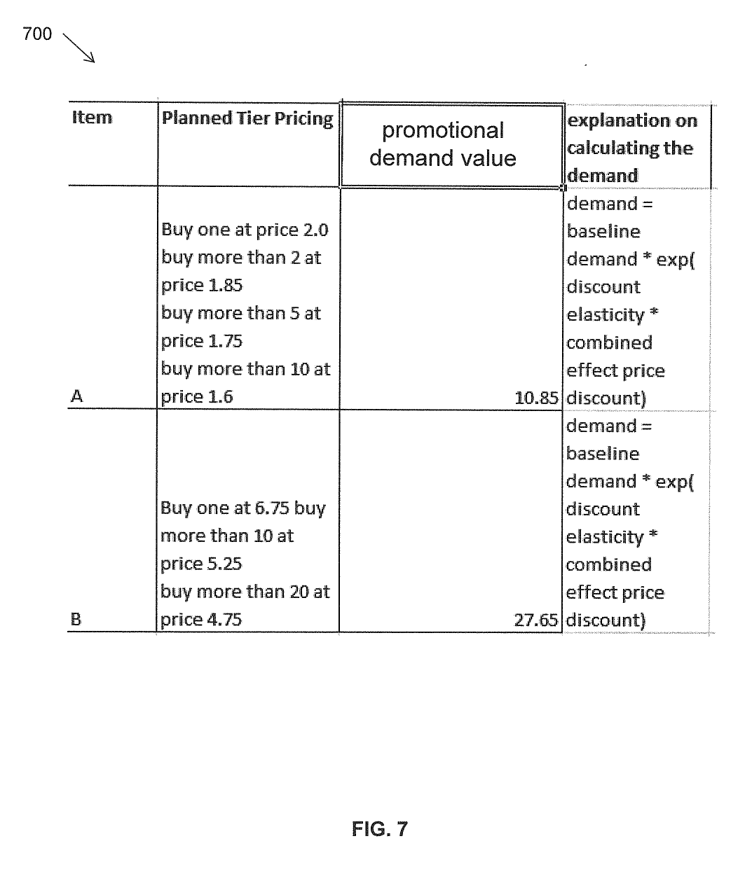

At block 240, a promotional demand value is generated. The promotional demand value represents an expected total demand for the item when the item is discounted in accordance with the tier pricing promotion plan (i.e., in accordance with the defined plurality of tier discount ranges). In one embodiment, the promotional demand value is generated by the demand prediction logic 135 based at least in part on the combined discount value. For example, in one embodiment, the promotional demand value for an item is generated based on the combined discount value, the baseline demand value, and the price elasticity value for the item. An example of generating promotional demand values is discussed later herein with respect to FIG. 7.

In one embodiment, experimentation may be performed by using the promotion forecasting tool 110 to adjust the tier discount ranges of the tier pricing promotion plan. Data results of the adjustments may be stored in a memory and compared. The promotion forecasting tool 110 may then repeat the method 200 to attempt to maximize the estimated demand. For example, the historical sales data may be re-analyzed with respect to the adjusted tier discount ranges and the numerical amount may be re-distributed across the adjusted tier discount ranges. An adjusted discount value may be generated based on the adjusted tier discount ranges and associated re-distributed values. An adjusted demand value may then be generated based on the adjusted discount value.

In this manner, the various aspects of a tier pricing promotion plan for an item can be consolidated into a single combined discount value. The combined discount value characterizes the effects of the tier pricing promotion plan and can be used to predict a future demand for the item when the tier pricing promotion plan is executed. The predicted demand (i.e., promotional demand value) may be used to place an order for the associated item and/or adjust an inventory level of the associated item, for example.

FIG. 3A illustrates one example embodiment of a table 310 of data representing the price elasticity and the baseline demand of two items A and B to be promoted via tier pricing. Again, a price elasticity value for an item represents a measure of how a demand for the item responds to a change in a price of the item. A baseline demand value for an item represents a demand for the item when the item is not discounted. In one embodiment, a price elasticity value for an item and a baseline demand value for an item may be provided as part of the historical sales data for the item. In another embodiment, a price elasticity value for an item and a baseline demand value for an item is generated by the promotion forecasting tool 110 (e.g., by the tier distribution logic 125) by operating on or analyzing the historical sales data.

FIG. 3B illustrates one example embodiment of a table 320 of data representing historical sales data for the items A and B of FIG. 3A. The table 320 includes columns for an item identifier, a transaction sequence, purchase units, purchase price, regular price, and price discount. The table 320 reflects a sales history of the items A and B for both discounted and undiscounted transactions. For example, for transaction sequence 1 for item A, two units of item A were purchased at a purchase price of $1.85 which is also the regular price for item A (the undiscounted price, 0% discount). For transaction sequence 5 for item A, four units of item A were purchased at a purchase price of $1.70 (at a discount of 8.11% off of the regular price of $1.85). In accordance with one embodiment, the tier distribution logic 125 is configured to analyze the historical sales data as discussed herein.

FIG. 4 illustrates one example embodiment of a table 400 of data representing a tier pricing promotion plan for a first item A of the two items A and B of FIG. 3A. The tier pricing promotion plan for item A is generated based at least in part on an analysis of the table 320 of historical sales data of FIG. 3B. The table 400 represents a tier pricing promotion plan for item A and includes an item identifier column and a planned tier pricing column. The planned tier pricing column defines a tier pricing strategy.

The tier pricing strategy for item A indicates that a single unit of item A may be purchased at a regular (undiscounted price) of $2.00, two to five units of item A may be purchased at a discounted price of $1.85, six to ten units of item A may be purchased at a discounted price of $1.75, and more than ten units of item A may be purchased at a discounted price of $1.60. In one embodiment, the tier pricing strategy for item A is determined based on an analysis of the historical sales data for item A in table 320. In accordance with another embodiment, the tier pricing strategy for item A is determined by a user as part of defining the tier pricing promotion plan for item A.

Table 400 also includes a planned tier number column and a tier price discount (TPD) column. The planned tier number column defines four price tiers (tier 1, tier 2, tier 3, and tier 4) for the tier pricing promotion plan for item A. The tier price discount (TPD) column defines a tier discount range for each tier having a TPD value. For example, for tier 1, the tier discount range is 0% to 7.5% which has a TPD value of 7.5%. For tier 2, the tier discount range is 7.5% to 12.5% which has a TPD value of 12.5%. For tier 3, the tier discount range is 12.5% to 20% which has a TPD value of 20%. For tier 4, the tier discount range is 20% and beyond which has a TPD value of >20%.

In one embodiment, the number of tiers and the tier discount ranges (having TPD values) are based on the planned tier pricing strategy. In another embodiment, the number of tiers and the tier discount ranges are defined by a user as part of defining the tier pricing promotion plan for item A. In a further embodiment, the number of tiers and the tier discount ranges may initially be based on the planned tier pricing strategy. However, a user may go back and adjust, for example, the tier discount ranges (e.g., using the graphical user interface provided by the visual user interface logic 120) in an attempt to increase the predicted demand for the item.

In one embodiment, the promotion forecasting tool 100 analyzes the historical sales data for item A in table 320 and determines a numerical amount (35) representing total units of item A sold. The historical sales data for item A in table 320 is also analyzed to determine which tier discount ranges the various units of the 35 total units sold fall into. Table 400 includes a sale unit column showing how the numerical amount (35) is distributed across the tier discount ranges based on the analysis.

As seen in table 400, 4 units are distributed (allocated) to the first tier discount range of 0% to 7.5%. That is, 4 units of item A sold at a discount of between 0% and 7.5% according to the historical sales data (see the explanation for sales units column of table 400). Similarly, 15 units are distributed (allocated) to the second tier discount range of 7.5% to 12.5%, 16 units are distributed (allocated) to the third tier discount range of 12.5% to 20%, and 0 units are distributed (allocated) to the fourth tier discount range. In this manner, the numerical amount (35), representing total units of item A sold, is distributed across the tier discount ranges forming a plurality of distributed values (4, 15, 16, 0).

Table 400 also includes a tier ratio column having a tier ratio value for each tier. The tier ratio values (11.43%, 42.86%, 45.71%, 0%) are generated by normalizing each of the distributed values (4, 15, 16, and 0) to the numerical amount (35) (i.e., dividing each distributed value by the numerical amount; see the explanation for tier ratio column of table 400) and expressing as a percentage.

FIG. 5 illustrates one example embodiment of a table 500 of data representing a tier pricing promotion plan for a second item B of the two items A and B of FIG. 3A. The tier pricing promotion plan for item B is generated based on an analysis of the table 320 of historical sales data of FIG. 3B. Table 500 is structured similarly to table 400 of FIG. 4, except that table 500 includes three price tiers instead of four price tiers. A numerical amount representing total units of item B sold, tier discount ranges having TPD values, distributed values, and tier ratio values are determined in a similar manner to that discussed above herein for item A.

Once the tiers have been defined, the historical sales data has been analyzed, and units of the items have been distributed across the tiers based on the analysis, the resulting tier pricing structures shown in table 400 and table 500 may be consolidated into a single representative value (i.e., a combined discount value) for each item. A combined discount value represents an effective price discount for an item that is to be promoted under a tier pricing promotion plan. FIG. 6 illustrates one example embodiment of a table 600 of data representing combined discount values for the items A and B of FIG. 3A generated based on the tables 400 and 500 of data of FIG. 4 and FIG. 5.

In accordance with one embodiment, a combined discount value is generated based at least in part on the plurality of distributed values (in particular, the tier ratio values derived from the plurality of distributed values) and the plurality of tier discount ranges (in particular, the TPD values of the tier discount ranges). For example, the combined discount values for item A and item B, shown in FIG. 6, may be generated in accordance with an algorithm where at least a portion of the algorithm is represented by the following expression:

$$CEPD ( i ) = ( \frac{{\sum }_{j ∈ Λ} S ( j ) * TPD ( j )}{{\sum }_{j ∈ Λ} S ( j )} ) = {\sum }_{j ∈ Λ} [ TPD ( j ) * TR ( j ) ] ,$$

where CEPD(i) is the combined effective price discount (or combined discount value) for item i, S(j) is the total sales units along the history where the purchase price is within the tier discount range j (i.e., the distribution value for tier discount range j), TPD(j) is the tier price discount value for tier discount range j, TR(j) is the tier ratio value for tier discount range j, and A is the set of tiers in the tier pricing promotion plan. In accordance with one embodiment, a combined discount value is generated by the combined discount logic 130 of the promotion forecasting tool 110.

As seen in table 600 of FIG. 6, the resultant combined discount value for item A is 15.36% and the resultant combined discount value for item B is 27.00%. As seen in the expression for CEPD above, a portion of the algorithm involves generating a product of a TPD value and a tier ratio (TR) value for each tier, and summing the resultant products. Therefore, when item A is promoted in accordance with the tier pricing promotion plan of FIG. 4, the effective price discount for item A is 15.36%. Similarly, when item B is promoted in accordance with the tier pricing promotion plan of FIG. 5, the effective price discount for item B is 27.00%. In this manner, the multiple tier pricing levels of a tier pricing promotion plan can be summarized and expressed as a single combined discount value which can be used in a demand model.

FIG. 7 illustrates one example embodiment of a table 700 of data representing promotional demand values for the items A and B of FIG. 3A generated based on the tables 310 and 600 of data of FIG. 3A and FIG. 6. A promotional demand value represents an expected total demand for an item when the item is discounted (promoted) in accordance with a tier pricing promotion plan. A promotional demand value may be generated using a demand model or algorithm that takes into account price elasticity and baseline demand, for example.

In accordance with one embodiment, promotional demand values for item A and item B, shown in FIG. 6, may be generated in accordance with an algorithm where at least a portion of the algorithm is represented by the following expression:

Demand=Baseline Demand*e^{(discount elasticity*CEPD)}

where Demand is the resultant promotional demand value for an item, Baseline Demand is the baseline demand value for an item from table 310 of FIG. 3A, discount elasticity is the price elasticity value for an item from table 310 of FIG. 3A, and CEPD is the combined discount value from table 600 of FIG. 6. As seen in FIG. 7, the promotional demand value for item A is 10.85 units, and the promotional demand value for item B is 27.65 units. In accordance with one embodiment, promotional demand values are generated by the demand prediction logic 135 of the promotion forecasting tool 100.

In other embodiments, a promotional demand value may be generated based on a combined discount value using other algorithms other than the algorithm given above by the expression for Demand. For example, one embodiment of such another algorithm may use price elasticity but not baseline demand. Another embodiment of such another algorithm may use a non-exponential function instead of an exponential function, for example. Other embodiments for determining the promotional demand value are possible as well.

In this manner, demand for an item may be predicted, taking into account the sales history of the item and price discounting of the item. The predicted demand information may be used to adjust order quantities for the item and predict future inventory levels of the item. In accordance with one embodiment, an order quantity for a retail item may be transformed based on a promotional demand value.

For example, a replenishment system can use this information to adjust order quantities and reduce inventory cost. A reduction in inventory cost of as little as 1% can amount to millions of dollars in savings per year for some retailers. In this manner, a retailer can more accurately forecast and manage demand for merchandise by accounting for the tier pricing promotion effects caused by a tier pricing promotion plan.

Systems, methods, and other embodiments that are associated with a computer application configured to execute on a computing device have been described, for providing forecasting and management of an item to be promoted via tier pricing. In one embodiment, historical sales data of the item are analyzed to distribute a total number of the item sold across a plurality of tier discount ranges in a data structure of a tier pricing promotion plan for the item, forming a plurality of distributed values. The distribution is based at least in part on discounted sales of the item reflected in the historical sales data. A combined discount value is generated based at least in part on the plurality of tier discount ranges and the plurality of distributed values. The combined discount value represents an effective price discount for the item. A promotional demand value is generated based at least in part on the combined discount value. The promotional demand value represents an expected total demand for the item when discounted according to the tier pricing promotion plan.

Computing Device Embodiment

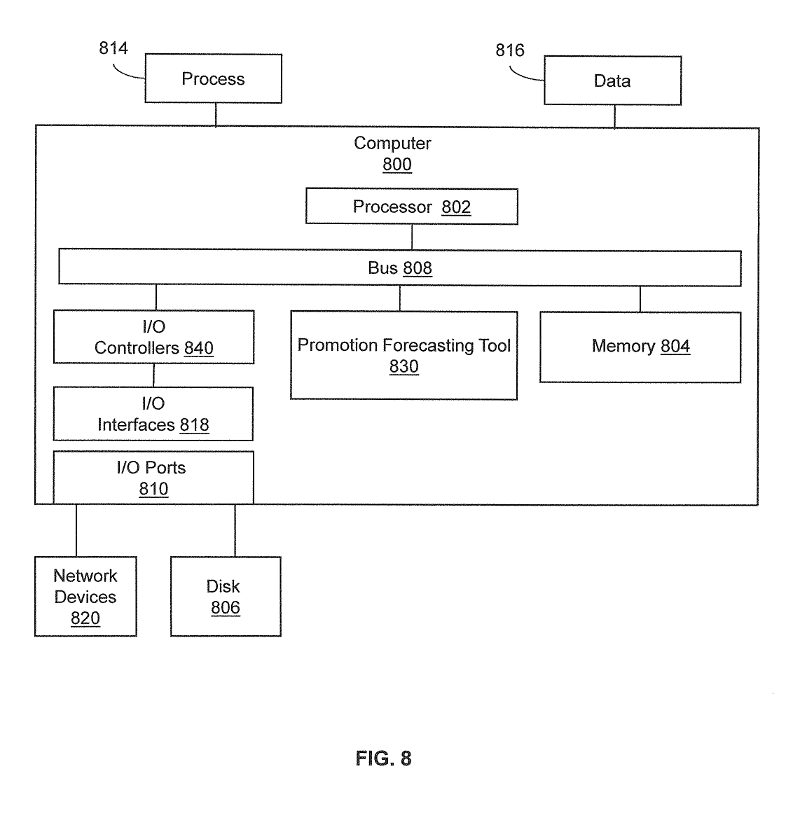

FIG. 8 illustrates an example computing device that is configured and/or programmed with one or more of the example systems and methods described herein, and/or equivalents. FIG. 8 illustrates one example embodiment of a computing device upon which an embodiment of a promotion forecasting tool may be implemented. The example computing device may be a computer 800 that includes a processor 802, a memory 804, and input/output ports 810 operably connected by a bus 808.

In one example, the computer 800 may include promotion forecasting tool 830 (corresponding to promotion forecasting tool 110 from FIG. 1) configured with a programmed algorithm as disclosed herein to determine a combined discount value for an item representing an effective price discount for the item when promoted in accordance with a tier pricing promotion plan. The combined discount value, and/or a promotional demand value determined using the combined discount value, may be displayed as values on a computing display device. The promotional demand value represents an expected total demand for the item when promoted in accordance with the tier pricing promotion plan. In different examples, the tool 830 may be implemented in hardware, a non-transitory computer-readable medium with stored instructions, firmware, and/or combinations thereof. While the tool 830 is illustrated as a hardware component attached to the bus 808, it is to be appreciated that in other embodiments, the tool 830 could be implemented in the processor 802, stored in memory 804, or stored in disk 806.

In one embodiment, tool 830 or the computer 800 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the forecasting and managing of tier-pricing promoted merchandise for a retailer. The means may also be implemented as stored computer executable instructions that are presented to computer 800 as data 816 that are temporarily stored in memory 804 and then executed by processor 802.

Tool 830 may also provide means (e.g., hardware, non-transitory computer-readable medium that stores executable instructions, firmware) for facilitating the predicting of tier-pricing promotion effects for retail items.

Generally describing an example configuration of the computer 800, the processor 802 may be a variety of various processors including dual microprocessor and other multi-processor architectures. A memory 804 may include volatile memory and/or non-volatile memory. Non-volatile memory may include, for example, ROM, PROM, and so on. Volatile memory may include, for example, RAM, SRAM, DRAM, and so on.

A storage disk 806 may be operably connected to the computer 800 via, for example, an input/output interface (e.g., card, device) 818 and an input/output port 810. The disk 806 may be, for example, a magnetic disk drive, a solid state disk drive, a floppy disk drive, a tape drive, a Zip drive, a flash memory card, a memory stick, and so on. Furthermore, the disk 806 may be a CD-ROM drive, a CD-R drive, a CD-RW drive, a DVD ROM, and so on. The memory 804 can store a process 814 and/or a data 816, for example. The disk 806 and/or the memory 804 can store an operating system that controls and allocates resources of the computer 800.

The computer 800 may interact with input/output devices via the i/o interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, and USB ports.

The computer 800 can operate in a network environment and thus may be connected to the network devices 820 via the i/o interfaces 818, and/or the i/o ports 810. Through the network devices 820, the computer 800 may interact with a network. Through the network, the computer 800 may be logically connected to remote computers. Networks with which the computer 800 may interact include, but are not limited to, a LAN, a WAN, and other networks.

### DEFINITIONS AND OTHER EMBODIMENTS

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving the data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

“Operable interaction”, as used herein, refers to the logical or communicative cooperation between two or more logics via an operable connection to accomplish a function.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A method implemented by a computing device configured to execute a computer application, wherein the computer application is configured to process data in electronic form, the method comprising:
analyzing historical sales data for an item with respect to a plurality of tier discount ranges of a tier pricing promotion plan for the item, wherein the historical sales data reflects discounted sales of units of the item;
distributing a numerical amount, representing total units of the item sold, across the plurality of tier discount ranges as defined in a data structure, wherein the distributing forms a plurality of distributed values and is based at least in part on the analyzing;
generating a combined discount value based at least in part on the plurality of tier discount ranges and the plurality of distributed values, wherein the combined discount value represents an effective price discount for the item; and
generating a promotional demand value for the item based at least in part on the combined discount value, wherein the promotional demand value represents an expected total demand for the item when a price for the item is discounted according to the tier pricing promotion plan.

2. The method of claim 1, wherein the generating of the combined discount value includes generating a plurality of tier ratio values based at least in part on normalizing the plurality of distributed values to the numerical amount.

3. The method of claim 1, wherein the generating of the promotional demand value is further based at least in part on a baseline demand value for the item, wherein the baseline demand value represents a demand for the item when the item is not discounted.

4. The method of claim 1, wherein the generating of the promotional demand value is further based at least in part on a price elasticity value for the item, wherein the price elasticity value represents a measure of how a demand for the item responds to a change in the price of the item.

5. The method of claim 1, further comprising:
adjusting the plurality of tier discount ranges in the data structure to form a plurality of adjusted tier discount ranges;
re-analyzing the historical sales data with respect to the plurality of adjusted tier discount ranges;
re-distributing the numerical amount across the plurality of adjusted tier discount ranges, wherein the re-distributing forms a plurality of re-distributed values and is based at least in part on the re-analyzing;
generating an adjusted discount value based at least in part on the plurality of adjusted tier discount ranges and the plurality of re-distributed values, wherein the adjusted discount value represents an effective adjusted price discount for the item; and
generating an adjusted demand value for the item based at least in part on the adjusted discount value, wherein the adjusted demand value represents an adjusted expected total demand for the item when discounted according to the tier pricing promotion plan.

6. The method of claim 1, further comprising reading at least the historical sales data from at least a second data structure of a database device.

7. The method of claim 1, further comprising displaying at least the promotional demand value on a display device.

8. The method of claim 1, further comprising placing an order for the item based at least in part on the promotional demand value.

9. The method of claim 1, further comprising adjusting an inventory level of the item based at least in part on the promotional demand value.

10. A computing system, comprising:
a tier distribution module, including instructions stored in a non-transitory computer-readable medium, configured to:
(i) analyze historical sales data for an item with respect to a plurality of tier discount ranges, wherein the historical sales data reflects discounted sales of units of the item, and
(ii) distribute a numerical amount, representing total units of the item sold, across the plurality of tier discount ranges as defined in a data structure, wherein the distributing forms a plurality of distributed values and is based at least in part on the analyzing;
a combined discount module, including instructions stored in the non-transitory computer-readable-medium, configured to generate a combined discount value based at least in part on the plurality of tier discount ranges and the plurality of distributed values, wherein the combined discount value represents an effective price discount for the item; and
a demand prediction module, including instructions stored in the non-transitory computer-readable medium, configured to generate a promotional demand value for the item based at least in part on the combined discount value, wherein the promotional demand value represents an expected total demand for the item when discounted according to the plurality of tier discount ranges.

11. The computing system of claim 10, further comprising a visual user interface module, including instructions stored in the non-transitory computer-readable medium, configured to facilitate inputting the historical sales data for the item into the tier distribution module.

12. The computing system of claim 10, further comprising a display screen configured to display and facilitate user interaction with at least a graphical user interface.

13. The computing system of claim 10, wherein the demand prediction module is configured to facilitate displaying of the promotional demand value for the item.

14. The computing system of claim 10, wherein the combined discount module is configured to generate a plurality of tier ratio values, as part of generating the combined discount value, based at least in part on normalizing the plurality of distributed values to the numerical amount.

15. The computing system of claim 10, wherein the demand prediction module is configured to generate the promotional demand value for the item further based at least in part on a baseline demand value for the item and a price elasticity value for the item, wherein the baseline demand value represents a demand for the item when the item is not discounted, and wherein the price elasticity value represents a measure of how a demand for the item responds to a change in a price of the item.

16. The computing system of claim 10, further comprising a database device configured to store at least the historical sales data.

17. A non-transitory computer-readable medium storing computer-executable instructions that are part of an algorithm that, when executed by a computer, cause the computer to perform a method, wherein the instructions comprise instructions configured for:
analyzing historical sales data for an item with respect to a plurality of tier discount ranges of a tier pricing promotion plan for the item, wherein the historical sales data reflects discounted sales of units of the item;
distributing a numerical amount, representing total units of the item sold, across the plurality of tier discount ranges as defined in a data structure, wherein the distributing forms a plurality of distributed values and is based at least in part on the analyzing;
generating a combined discount value based at least in part on the plurality of tier discount ranges and the plurality of distributed values, wherein the combined discount value represents an effective price discount for the item; and
generating a promotional demand value for the item based at least in part on the combined discount value, wherein the promotional demand value represents an expected total demand for the item when discounted according to the tier pricing promotion plan.

18. The non-transitory computer-readable medium of claim 17, wherein the instructions configured for generating the combined discount value include instructions configured for generating a plurality of tier ratio values based at least in part on normalizing the plurality of distributed values to the numerical amount.

19. The non-transitory computer-readable medium of claim 17, wherein the instructions configured for generating the promotional demand value include instructions configured for combining a baseline demand value for the item and a price elasticity value for the item with the combined discount value, wherein the baseline demand value represents a demand for the item when the item is not discounted, and wherein the price elasticity value represents a measure of how a demand for the item responds to a change in a price of the item.

20. The non-transitory computer-readable medium of claim 17, wherein the instructions further include instructions configured for populating an output data structure of the tier pricing promotion plan with at least the combined discount value and the promotional demand value.
